(19) United States
(12) Patent Application Publication
(10) Pub. No.: US 2020/0103327 A1
(43) Pub. Date: Apr. 2, 2020

(54) SYSTEM AND METHOD FOR OBJECT DETECTION IN HOLOGRAPHIC LENS-FREE IMAGING BY CONVOLUTIONAL DICTIONARY LEARNING AND ENCODING

(71) Applicant: miDiagnostics NV, Leuven (BE)

(72) Inventors: Florence YELLIN, Baltimore, MD (US); Benjamin D. HAEFFELE, Oakland, CA (US); Rene VIDAL, Baltimore, MD (US)

(21) Appl. No.: 16/347,190

(22) PCT Filed: Nov. 3, 2017
(86) PCT No.: PCT/US17/59933

§ 371 Date: May 2, 2019

Related U.S. Application Data
(60) Provisional application No. 62/417,720, filed on Nov. 4, 2016.

(51) Int. Cl. G01N 15/02; G03H 1/08

(52) U.S. Cl. CPC G01N 15/0227; G02B 5/32; G03H 1/0866

(57) ABSTRACT

A system for detecting objects in a specimen includes a chamber for holding at least a portion of the specimen. The system also includes a lens-free image sensor for obtaining a holographic image of the portion of the specimen in the chamber. The system further includes a processor in communication with the image sensor, the processor programmed to obtain a holographic image having one or more objects depicted therein. The processor is further programmed to obtain at least one object template representing the object to be detected, and to detect at least one object in the holographic image.

### CROSS-REFERENCE TO RELATED APPLICATIONS

This application claims priority to U.S. Provisional Application No. 62/417,720 titled “System and Method for Object Detection in Holographic Lens-Free Imaging by Convolutional Dictionary Learning and Encoding”, filed Nov. 4, 2016, the entire disclosure of which is incorporated herein by reference.

### BACKGROUND

The present disclosure relates to holographic image processing, and in particular, object detection in holographic images.

Lens-free imaging (LFI) is emerging as an advantageous technology for biological applications due to its compactness, light weight, minimal hardware requirements, and large field of view, especially when compared to conventional microscopy. One such application is high-throughput cell detection and counting in an ultra-wide field of view. Conventional systems use focusing lenses and result in relatively restricted fields of view. LFI systems, on the other hand, do not require such field-of-view limiting lenses. However, detecting objects in a lens-free image is particularly challenging because the holograms—interference patterns that form when light is scattered by objects—produced by two objects in close proximity can interfere with each other, which can make standard holographic reconstruction algorithms (for example, wide-angular spectrum reconstruction) produce reconstructed images that are plagued by ring-like artifacts such as those shown in FIG. 1 (left). As a result, simple object detection methods such as thresholding can fail because reconstruction artifacts may appear as dark as the object being imaged, which can produce many false positives.

Template matching is a classical algorithm for detecting objects in images by finding correlations between an image patch and one or more pre-defined object templates, and is typically more robust to reconstruction artifacts, which are less likely to look like the templates. However, one disadvantage of template matching is that it requires the user to pre-specify the object templates: usually templates are patches extracted by hand from an image and the number of templates can be very large if one needs to capture a large variability among object instances. Furthermore, template matching requires the post-processing via non-maximal suppression and thresholding, which are sensitive to several parameters.

Sparse dictionary learning (SDL) is an unsupervised method for learning object templates. In SDL, each patch in an image is approximated as a (sparse) linear combination of the dictionary atoms (templates), which are learned jointly with the sparse coefficients using methods such as K-SVD. However, SDL is not efficient as it requires a highly redundant number of templates to accommodate the fact that a cell can appear in multiple locations within a patch. In addition, SDL requires every image patch to be coded using the dictionary, even if the object appears in only a few patches of the image.

### SUMMARY

The present disclosure describes a convolutional sparse dictionary learning approach to object detection and counting in LFI. The present approach is based on a convolutional model that seeks to express an input image as the sum of a small number of images formed by convolving an object template with a sparse location map (see FIG. 1). Since an image contains a small number of instances relative to the number of pixels, object detection can be done efficiently using convolutional sparse coding (CSC), a greedy approach that extends the matching pursuit algorithm for sparse coding. Moreover, the collection of templates can be learned automatically using convolutional sparse dictionary learning (CSDL), a generalization of K-SVD to the convolutional case.

The presently-disclosed approach overcomes many of the limitations and disadvantages of other object detection methods, while retaining their strengths. Similar to template matching, CSC is not fooled by reconstruction artifacts because such artifacts do not resemble the objects being detected. Unlike template matching, CSC does not use image patches as templates, but instead it learns the templates directly from the data, rather than using predefined example objects. Another advantage over template matching is that CSC does not depend on post-processing steps and many parameters because the coding step directly locates objects in an image. Moreover, if the number of objects in the image is known a priori, CSC is entirely parameter free; and if the number of objects is unknown, there is a single parameter to be tuned. In addition, patch-based dictionary learning and coding methods must be used in conjunction with other object detection methods, like thresholding. In contrast, CSC and coding is a stand-alone method for object detection. CSC also does not suffer from the inefficiencies of patch-based dictionary coding. This is because the runtime of CSC scales with the number of objects in the image and the number of templates needed to describe all types of object occurrences, while the complexity of patch-based methods scales with the number of patches and the (possibly larger) number of templates. These advantages make the presently-disclosed CSC technique particularly suited for cell detection and counting in LFI.

### BRIEF DESCRIPTION OF THE DRAWINGS

For a fuller understanding of the nature and objects of the disclosure, reference should be made to the following detailed description taken in conjunction with the accompanying drawings, in which:

FIG. 1 depicts the presently-disclosed technique, wherein the image on the left is a traditionally reconstructed hologram, the six templates shown were learned via convolutional dictionary learning, during convolutional dictionary coding, the input image was coded as the sum of convolutions of dictionary elements with delta functions of varying strengths, resulting in the image on the right.

FIG. 2 is a comparison of patch based dictionary coding and CSC in terms of counting accuracy and runtime;

FIG. 3 is a flowchart of a method for counting objects according to an embodiment of the present disclosure;

FIG. 4 depicts a system according to another embodiment of the present disclosure;

FIG. 5 depicts local reconstruction of a hologram acquired by a system according to another embodiment of the present disclosure; and

FIG. 6 depicts remote reconstruction of a hologram acquired by a system according to another embodiment of the present disclosure.

### DETAILED DESCRIPTION

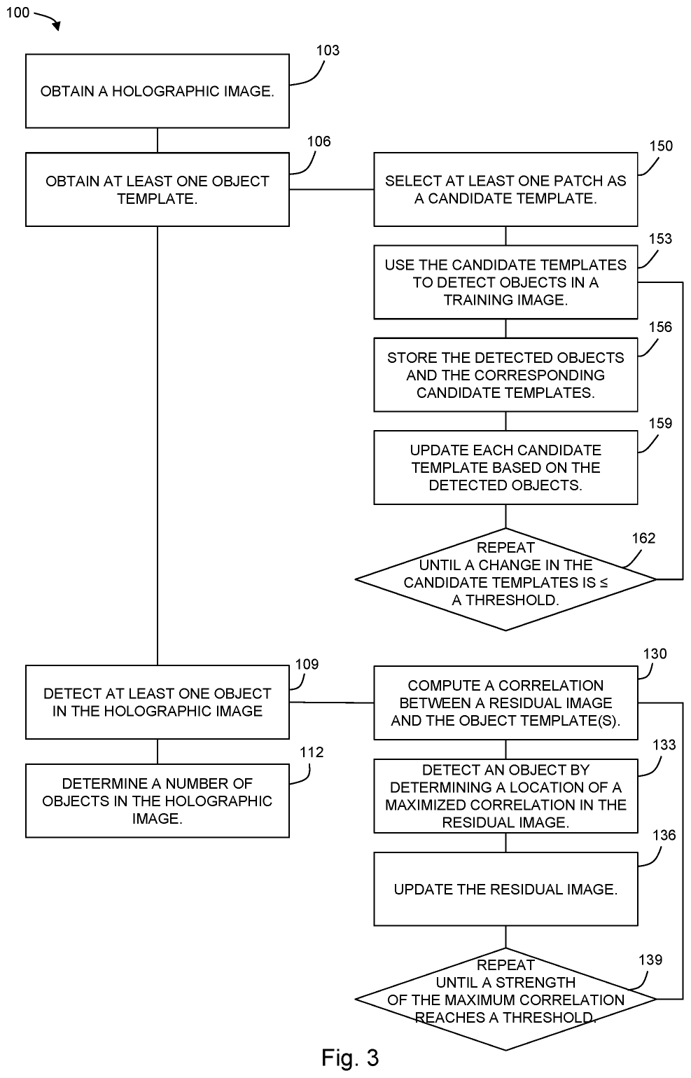

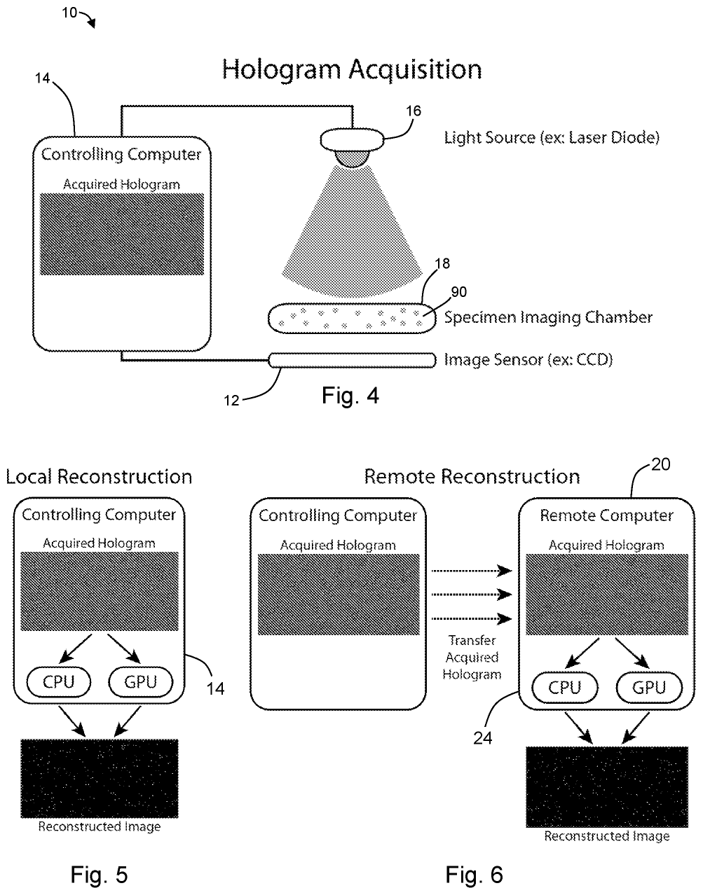

With reference to FIG. 3, the present disclosure may be embodied as a method 100 for detecting objects in a holographic image. The method 100 includes obtaining 103 a holographic image, such as, for example, a holographic image of a fluid containing a plurality of objects. At least one object template is obtained 106, wherein the at least one object template is a representation of the object to be counted. More than one object template can be used and the use of a greater number of object templates may improve object detection. For example, each object template may be a unique (amongst the object templates) representation of the object to be detected, for example, a representation of the object in a different orientation of the object, morphology, etc. In embodiments, the number of object templates may be 2, 3, 4, 5, 6, 10, 20, 50, or more, including all integer number of objects therebetween. In some embodiments, the objects to be detected are different objects, for example, red blood cells and white blood cells. In such embodiments, the object templates may include representations of the different objects such that the objects can be detected, counted and/or differentiated.

The method 100 includes detecting 109 at least one object in the holographic image. In some embodiments, the step of detecting at least one object comprises computing 130 a correlation between a residual image and the at least one object template. Initially, the residual image is the holographic image, but as steps of the method are repeated the residual image is updated with the results of each iteration of the method (as further described below). Where more than one object template is obtained 106, the correlations are computed 130 between the residual image and each object template. An object is detected 133 in the residual image by determining a location in the residual image that maximizes the computed 130 correlation. The strength of the maximized correlation is also determined.

The residual image is updated 139 by subtracting from the residual image the detected 133 object template convolved with a delta function (further described below) at the determined location and weighting this by the strength of the maximized correlation. The steps of computing 130 a correlation, determining 133 a location of the maximized correlation, and updating 136 the residual image are repeated 139 until a strength of the correlation reaches a pre-determined threshold. With each iteration, the updated 136 residual image is utilized. For example, where the holographic image is initially used as the residual image, the updated 136 residual image is used in subsequent iterations. As the iterations proceed, the strength of correlation decreases, and the process may be stopped when, for example, the strength of the correlation is less than or equal to the pre-determined threshold. The pre-determined threshold may be determined by any method as will be apparent in light of the present disclosure, for example, by cross-validation, where the results are compared to a known-good result to determine whether the method should be iterated further. The threshold can be selected by any model selection technique, such as, for example, cross validation.

In some embodiments, the step of obtaining 106 at least one object template includes selecting 150 at least one patch from the holographic image as candidate templates. The candidate templates are used to detect 153 at least one object in the holographic image. For example, the at least one object may be detected 153 using the correlation method described above. The detected 153 object is stored 156 along with the candidate template. Where more than one candidate templates are used, the objects and the corresponding templates are stored. The at least one candidate template is updated 159 based upon the detected objects corresponding to that template.

The process of detecting 153 an object, storing 156 the object and the candidate template, and updating 159 the candidate template based on the detected object is repeated 162 until a change in the candidate template is less than a pre-determined threshold. For learning the templates, the process can be done with a single holographic image, where random patches are selected to initialize the “templates,” and object detection is performed on the same image from which the templates were initialized. Once the templates are learned, they can be used to do object detection in a second image.

The method 100 may include determining 112 a number of objects in the holographic image based on the at least one detected object. For example, in the above-described exemplary steps for detecting 109 at least one object in the holographic image, with every detection of an object, a total number of detected objects may be updated and the number of objects in the holographic image may be determined 112.

In another aspect, the present disclosure may be embodied as a system 10 for detecting objects in a specimen. The specimen 90 may be, for example, a fluid. The system 10 comprises a chamber 18 for holding at least a portion of the specimen 90. In the example where the specimen is a fluid, the chamber 18 may be a portion of a flow path through which the fluid is moved. For example, the fluid may be moved through a tube or micro-fluidic channel, and the chamber 18 is a portion of the tube or channel in which the objects will be counted. The system 10 may have a lens-free image sensor 12 for obtaining holographic images. The image sensor 12 may be, for example, an active pixel sensor, a charge-coupled device (CCD), or a CMOS active pixel sensor. The system 10 may further include a light source 16, such as a coherent light source. The image sensor 12 is configured to obtain a holographic image of the portion of the fluid in the chamber 18, illuminated by light from the light source 16, when the image sensor 12 is actuated. A processor 14 may be in communication with the image sensor 12.

The processor 14 may be programmed to perform any of the methods of the present disclosure. For example, the processor 14 may be programmed to obtain a holographic image of the specimen in the chamber 18; obtain at least one object template; and detect at least one object in the holographic image based on the object template. In an example of obtaining a holographic image, the processor 14 may be programmed to cause the image sensor 12 to capture a holographic image of the specimen in the chamber 18, and the processor 14 may then obtain the captured image from the image sensor 12. In another example, the processor 14 may obtain the holographic image from a storage device.

With reference to FIGS. 5-6, the system 10 may be configured for “local” reconstruction, for example, where image sensor 12 and the processor 14 make up the system 10. The system 10 may further include a light source 16 for illuminating a specimen. For example, the light source 16 may be a coherent light source, such as, for example, a laser diode providing coherent light. The system 10 may further include a specimen imaging chamber 18 configured to contain the specimen during acquisition of the hologram. In other embodiments (for example, as depicted in FIG. 6), the system 20 is configured for remote” reconstruction, where the processor 24 is separate from the image sensor and receives information from the image sensor through, for example, a wired or wireless network connection, a flash drive, etc.

The processor may be in communication with and/or include a memory. The memory can be, for example, a Random-Access Memory (RAM) (e.g., a dynamic RAM, a static RAM), a flash memory, a removable memory, and/or so forth. In some instances, instructions associated with performing the operations described herein (e.g., operate an image sensor, generate a reconstructed image) can be stored within the memory and/or a storage medium (which, in some embodiments, includes a database in which the instructions are stored) and the instructions are executed at the processor.

In some instances, the processor includes one or more modules and/or components. Each module/component executed by the processor can be any combination of hardware-based module/component (e.g., a field-programmable gate array (FPGA), an application specific integrated circuit (ASIC), a digital signal processor (DSP)), software-based module (e.g., a module of computer code stored in the memory and/or in the database, and/or executed at the processor), and/or a combination of hardware- and software-based modules. Each module/component executed by the processor is capable of performing one or more specific functions/operations as described herein. In some instances, the modules/components included and executed in the processor can be, for example, a process, application, virtual machine, and/or some other hardware or software module/component. The processor can be any suitable processor configured to run and/or execute those modules/components. The processor can be any suitable processing device configured to run and/or execute a set of instructions or code. For example, the processor can be a general purpose processor, a central processing unit (CPU), an accelerated processing unit (APU), a field-programmable gate array (FPGA), an application specific integrated circuit (ASIC), a digital signal processor (DSP), and/or the like.

Some instances described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other instances described herein relate to a computer program product, which can include, for example, the instructions and/or computer code discussed herein.

Examples of computer code include, but are not limited to, micro-code or micro-instructions, machine instructions, such as produced by a compiler, code used to produce a web service, and files containing higher-level instructions that are executed by a computer using an interpreter. For example, instances may be implemented using Java, C++, .NET, or other programming languages (e.g., object-oriented programming languages) and development tools. Additional examples of computer code include, but are not limited to, control signals, encrypted code, and compressed code.

In an exemplary application, the methods or systems of the present disclosure may be used to detect and/or count objects within a biological specimen. For example, an embodiment of the system may be used to count red blood cells and/or white blood cells in whole blood. In such an embodiment, the object template(s) may be representations of red blood cells and/or white blood cells in one or more orientations. In some embodiments, the biological specimen may be processed before use with the presently-disclosed techniques.

In another aspect, the present disclosure may be embodied as a non-transitory computer-readable medium having stored thereon a computer program for instructing a computer to perform any of the methods disclosed herein. For example, a non-transitory computer-readable medium may include a computer program to obtain a holographic image having one or more objects depicted therein; obtain at least one object template representing the object to be detected; and detect at least one object in the holographic image.

### Further Description

Given an observed image Ω→ [symbol] ⁺, Ω⊂ [symbol] ² obtained using, e.g., wide-angular spectrum reconstruction, assume that the image contains N instances of an object at locations {(xᵢ, yᵢ)}ᵢ₌₁^{N}. Both the number of instances and their locations are assumed to be unknown. Suppose also that K object templates {dₖ: Ω→ [symbol] ²}ₖ₌₁^{K}, ω⊂Ω capture the variations in shape of the object across multiple instances. Let Iᵢ be an image that contains only the i^{th} instance of the object at location (xᵢ, yᵢ) and let kᵢ be the template that best approximates the i^{th} instance. As such:

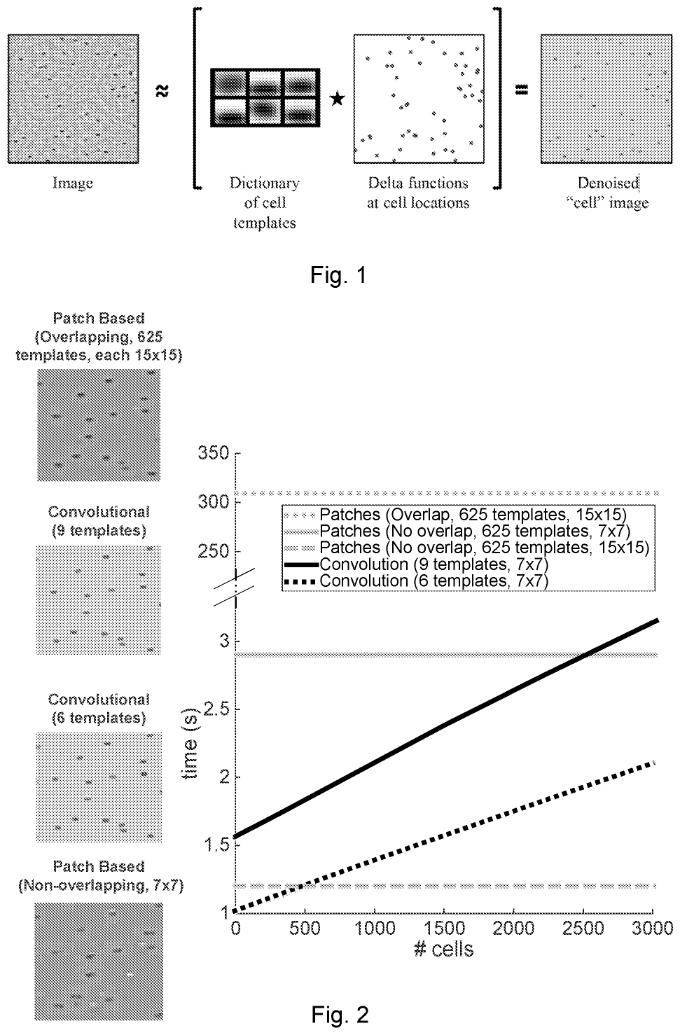

I_{i(x,y)}≈dₖ_{ᵢ}(x−xᵢ,y−yᵢ)=dₖ_{ᵢ}(x,y)★δ(x−xᵢ,y−yᵢ), (1)

where ★ denotes convolution. I can be decomposed as I≈Σᵢ₌₁^{N}Iᵢ, so that

$$I ( x , y ) \approx {\sum }_{i = 1}^{N} {α}_{i} {d}_{{k}_{i}} ( x , y ) ★δ ( x - {x}_{i} , y - {y}_{i} ) , \qquad ( 2 )$$

where the variable αᵢ ∈{0,1} is such that αᵢ=1 if the i^{th} instance is present and αᵢ=0 otherwise, and is introduced to account for the possibility that there are fewer object instances in I when N is an upper bound for the number of objects. In practice, αᵢ ∈[0,1] can be relaxed so that the magnitude of αᵢ measures the strength of the detection. Observe that the same template can be chosen by multiple object instances, so that K<<N. FIG. 1 provides a pictorial description of Equation (2).

Equation (2) is a special case of the general sparse convolutional approximation, in which an image is described as the sum of convolutions of sparse (in the l₀ sense) filters {Zᵢ}ᵢ₌₁^{N} with templates: I≈Σᵢ₌₁^{N}dₖ_{ᵢ} ★Zᵢ. Some approaches for tackling the general convolutional dictionary learning and coding problem include convexifying the objective and using greedy methods.

### Cell Detection by Convolutional Sparse Coding

Assume for the time being that the templates {dₖ}ₖ₌₁^{K} were known. Given an image I, the goal is to find the number of object instances N (object counting) and their locations {(xᵢ, yᵢ)}ᵢ₌₁^{N} (object detection). As a byproduct, the template kᵢ that best approximates the i^{th} instance is estimated. This problem can be formulated as

$${min}_{\{ {α}_{i} , {k}_{i} , {x}_{i} , {y}_{i} \}} {‖ I - {\sum }_{i = 1}^{N} {α}_{i} {d}_{{k}_{i}} {★δ}_{{x}_{i} , {y}_{i}} ‖}_{{𝓁}_{2}}^{2} \qquad ( 3 )$$

where δₓ_{ᵢ}_{,y}_{ᵢ} is a shorthand notation for δ(x−xᵢ, y−yᵢ).

Rather than solving problem (3) for all N objects in the image in one step, a greedy method is used to detect objects one at a time (N steps are needed). This approach is an application of matching pursuit for sparse coding to a convolutional objective. Let Rᵢ be the part of the input image that has not yet been coded, called the residual image. Initially, none of the image has been coded so R₀=I. After all N objects have been coded, the residual R_{N} will contain background noise but no objects. The basic object detection step that is used to locate the i^{th} object can be formulated as

$${min}_{{α}_{i} , {k}_{i} , {x}_{i} , {y}_{i}} {‖ {R}_{i - 1} - {α}_{i} {δ}_{{x}_{i} , {y}_{i}} ★ {d}_{{k}_{i}} ‖}_{{𝓁}_{2}}^{2} , \qquad ( 4 )$$

For a fixed αᵢ, it can be shown that the minimization problem (4) is equivalent to the maximization problem

$${max}_{{k}_{i} , {x}_{i} , {y}_{i}} 〈 {R}_{i - 1} ⊙ {d}_{{k}_{i}} , {δ}_{{x}_{i} , {y}_{i}} 〉 , \qquad ( 5 )$$

where ⊙ denotes correlation and [symbol] ⋅,⋅ [symbol] denotes the inner product. Notice that the solution to problem (5) is to compute the correlation of Rᵢ₋₁ with all templates dₖ and select the template and the location that give the maximum correlation (similar to template matching). Given the optimal kᵢ, xᵢ, yᵢ, solving for αᵢ in (4) is a simple quadratic problem, whose solution can be computed in closed form. These observations lead to the CSC method in Method 1.

| METHOD 1 (Convolutional Sparse Coding) | |
|---|---|
| procedure CSC(I, D) | |
| Choose threshold T | |
| Initialize R₀ = I, \hat{α}₀ = ∞, and i = 0 | |
| Compute correlation matrix Q₀ = R₀ ⊙ [d₁, . . . , d_{K}] | |
| while \hat{α}ᵢ > T do | [symbol] Termination criteria |
| αᵢ₊₁ at ← max Qᵢ | |
| $( {x}_{i + 1} , {y}_{i + 1} , {k}_{i + 1} ) ← arg {max}_{x , y , z} {Q}_{i}$ | |
| | [symbol] Detect one object per iteration |
| \hat{α}ᵢ₊₁ ← αᵢ₊₁/α₁ | |
| ${R}_{i + 1} ← {R}_{i} - {α}_{i + 1} {d}_{{k}_{i + 1}} {★δ}_{{x}_{i + 1} , {y}_{i + 1}}$ | |
| | [symbol] Update residual |
| Qᵢ₊₁ ← Rᵢ₊₁ ⊙ [d₁, . . . , d_{K}] | |
| | [symbol] Update correlation matrix |

```
    i ← i + 1
  end while
end procedure
```

Method 1 can be efficiently implemented by noticing that if the size of the templates is m² and the size of the image is M², then m<<M. Therefore, K [m²] * [M²] can be done only once, and after the first iteration, subsequent iterations can be done with only local updates on the scale of m². Further efficiency may be gained by noticing that the update of Qᵢ involves local changes around (xᵢ, yᵢ), hence one can use a max-heap implementation to store the large (KM²) matrix Q. If Q is stored as a matrix, the expensive operation max(Q) must be done at each iteration. If instead, Q is stored as a max-heap, there is an added cost per iteration of updating K(2m−1)² elements in the heap, but max(Q) requires no computation. The computational gain from eliminating the N max(·) operations far outweighs the cost of adding NK(2m−1)² heap-updates.

### Termination Criteria for Convolutional Sparse Coding.

Because one object is located during each iteration of the CSC method, counting accuracy is affected by when the iterative method is terminated. The sparse coefficients {αᵢ} decrease with i as the chosen objects in the image decreasingly resemble the templates. In some embodiments, the algorithm is terminated when \hat{α}_{N}=α_{N}/α₁≤T, where T is a threshold chosen by, for example, cross validation. This termination criteria enables CSC to be used to code N objects when N is not known a priori.

Template Training with Convolutional Sparse Dictionary Learning (CSDL)

Consider now the problem of learning the templates {dₖ}ₖ₌₁^{K}. The CSDL method minimizes the objective in (3), but now also with respect to {dₖ}ₖ₌₁^{K} subject to the constraint ∥dₖ∥₂=1. In general, this would require solving a non-convex optimization problem, so a greedy approximation that uses a convolutional version of K-SVD, which alternates between CSC and updating the dictionary, was employed. During the coding update step, the dictionary is fixed, and the sparse coefficients and object locations are updated using the CSC algorithm. During the dictionary update step, the sparse coefficients and object locations are fixed, and the object templates are updated one at a time using singular value decomposition. An error image associated with the template dₚ is defined as Eₚ=I−Σ_{i ∉Δp}αᵢdₖ_{ᵢ}*δₓ_{ᵢ}_{, y}_{ᵢ}, where Δp={i: kᵢ=p}. The optimization problem to update dₚ can thus be formulated as

$${min}_{{d}_{p}} {‖ {E}_{p} - {\sum }_{i ∈ {Δ}_{p}}^{ } {α}_{i} {δ}_{{x}_{i} , {y}_{i}} ★ {d}_{p} ‖}_{{𝓁}_{2}}^{2} \qquad ( 6 )$$

Note that patches (the same size as the templates) can be extracted from Eₚ centered at {(xᵢ, yᵢ)}_{i∉Δp}, and problem (6) can be reduced to the standard patch-based dictionary update problem. This leads to the method described in Method 2. Once a dictionary has been learned from training images, it can be used for object detection and counting via CSC in new test images.

METHOD 2 (Convolutional Sparse Dictionary Learning)

```
procedure CSDL(I)
  Choose numbers of iterations J and templates K
  Initialize D₀ with random, normalized patches of I
  for j = 0 : J − 1) do
    {xᵢ^{j+1}, yᵢ^{j+1}, kᵢ^{j+1}, αᵢ^{j+1}}ᵢ₌₁^{N} ← CSC(I, D^{j})
    for p = 1 : K do
      Δₚ ← {i : kᵢ^{j+1} = p}
      n = ∥Δₚ∥₀ [symbol]  number patches coded with dₚ
      if n > 1 then
        Eₚ ← I − Σ_{i∉Δ}^{ₚ} αᵢ^{j+1} dₖ^{ᵢ}^{^{j+1}}^{j} ★ δₓ^{ᵢ}^{^{j+1}}_{,y}^{ᵢ}^{^{j+1}}
        {eₗ}ₗ₌₁ⁿ ←vectorized patches from Eₚ
        centered at {(xᵢ^{j+1},yᵢ^{j+1})}_{iϵΔ}^{ₚ}
        (dₚ^{j+1}, αᵢ^{j+1}) ← SVD([e₁, ... , eₙ])
      else
        dₚ^{j+1} ←normalized image patch with the
        largest reconstruction error
      end if
    end for
  end for
end procedure
```

### EXEMPLARY EMBODIMENT

The disclosed CSDL and CSC methods were applied to the problem of detecting and counting red and white blood cells in holographic lens-free images reconstructed using wide-angular spectrum reconstruction. A data set of images of anti-coagulated human blood samples from ten donors was employed. From each donor, two types of blood samples were imaged: (1) diluted (300:1) whole blood, which contained primarily red blood cells (in addition to a much smaller number of platelets and even fewer white blood cells); and (2) white blood cells mixed with lysed red blood cells. White blood cells were more difficult to detect due to the lysed red blood cell debris. All blood cells were imaged in suspension while flowing through a micro-fluidic channel. Hematology analyzers were used to obtain “ground truth” red and white blood cell concentrations from each of the ten donors. The true counts were computed from the concentrations provided by the hematology analyzer, the known dimensions of the micro-fluidic channel, and the known dilution ratio. For the present comparison, once the presently-disclosed method was used to count cells in an image, the count was converted to concentration using the dilution ratio.

CSDL was used to learn four dictionaries, each learned from a single image: a dictionary was learned for each imager (I1 and I2) and each blood sample type (RBC and WBC). Ten iterations of the CSDL dictionary were used to learn six red blood cell templates and seven white blood cell templates. The RBC and WBC templates were 7×7 and 9×9 pixels, respectively (WBCs are typically larger than RBCs). CSC was then applied to all data sets, approximately 2,700 images in all (about 240, 50, 200, and 50 images per donor from datasets I1-RBC, I2-RBC, I1-WBC, and I2-WBC, respectively). Table 1 shows the error rate of the mean cell counts compared to cell counts from a hematology analyzer.

TABLE 1
% error of cell counts obtained using CSDL and CSC compared to
extrapolated cells counts from a hematology analyzer.

| Donor # | I1-RBC | I2-RBC | I1-WBC | I2-WBC |
|---|---|---|---|---|
| 1 | −1.8% | — | −10.6% | — |
| 2 | −6.3% | — | −3.3% | — |
| 3 | −4.6% | — | −43.0% | — |
| 4 | 2.7% | — | −28.4% | — |
| 5 | 10.6% | — | −36.2% | — |
| 6 | — | −9.2% | — | −8.1% |
| 7 | — | 10.1% | — | −24.6% |
| 8 | — | −0.7% | — | 11.4% |
| 9 | — | 8.7% | — | 12.1% |
| 10 | — | 4.4% | — | −5.3% |
| Mean \|% Error\| | 5.2% | 6.7% | 24.3% | 12.3% |

Finally, the results obtained using convolutional dictionary learning and coding are compared to results obtained from standard patch-based dictionary coding in FIG. 2. Notice that there is a tradeoff between image reconstruction time and reconstruction quality when using patch-based sparse dictionary coding. Notice also that the runtime of CSC is dependent on the number of cells to be detected in the image and the number of templates required to describe the variation expected among cells (more variation meaning more templates are required). Typical RBC images contain about 2,500 cells, while WBC images only contain around 250 cells.

With respect to the instant specification, the following description will be understood by those of ordinary skill such that the images referred to herein do not need to be displayed at any point in the method, and instead represent a file or files of data produced using one or more lens-free imaging techniques, and the steps of restructuring these images mean instead that the files of data are transformed to produce files of data that can then be used to produce clearer images or, by statistical means, analyzed for useful output. For example, an image file of a sample of blood may be captured by lens free imaging techniques. This file would be of a diffraction pattern that would then be mathematically reconstructed into second file containing data representing an image of the sample of blood. The second file could replace the first file or be separately stored in a computer readable media. Either file could be further processed to more accurately represent the sample of blood with respect to its potential visual presentation, or its usefulness in terms of obtaining a count of the blood cells (of any type) contained in the sample. The storage of the various files of data would be accomplished using methods typically used for data storage in the image processing art.

Although the present disclosure has been described with respect to one or more particular embodiments, it will be understood that other embodiments of the present disclosure may be made without departing from the spirit and scope of the present disclosure. The following are non-limiting sample claims intended only to illustrate embodiments of the disclosure.

What is claimed is:

1. A system for detecting objects in a specimen, the system comprising:
a chamber for holding at least a portion of the specimen;
a lens-free image sensor for obtaining a holographic image of the portion of the specimen in the chamber; and
a processor in communication with the image sensor, the processor programmed to:
(a) obtain a holographic image having one or more objects depicted therein;
(b) obtain at least one object template representing the object to be detected; and
(c) detect at least one object in the holographic image.

2. The system of claim 1, wherein the processor is further programmed to determine, based on the at least one detected object, a number of objects in the holographic image.

3. The system of claim 1, wherein the processor is further programmed to detect at least one object by:
(c1) computing a correlation between a residual image and the at least one object template, wherein the residual image is the holographic image;
(c2) determining a location in the residual image that maximizes the computed correlation as a detected object, and determining a strength of the maximized correlation;
(c3) updating the residual image as a difference between the residual image and the object convolved with a delta function at the determined location and weighted by the strength of the maximized correlation; and
(c4) repeating steps (c1)-(c3) using the updated residual image until the strength of the maximized correlation reaches a pre-determined threshold.

4. The system of claim 1, wherein the processor is further programmed to obtain at least one object template by:
(b1) selecting at least one patch from the holographic image as a candidate template;
(b2) detecting at least one object in a second holographic image using the candidate template;
(b3) storing the detected objects and the corresponding candidate template;
(b4) updating the candidate template based upon the corresponding detected objects; and
(b5) repeating steps (b2)-(b4) until a change in the candidate template is less than a pre-determined threshold.

5. The system of claim 1, wherein the image sensor is an active pixel sensor, a CCD, or a CMOS active pixel sensor.

6. The system of claim 1, further comprising a coherent light source.

7. A method for detecting objects in a holographic image, comprising:
(a) obtaining a holographic image having one or more objects depicted therein;
(b) obtaining at least one object template representing the object to be detected; and
(c) detecting at least one object in the holographic image using the at least one object template.

8. The method of claim 7, further comprising determining, based on the at least one detected object, a number of objects in the holographic image.

9. The method of claim 7, wherein the step of detecting at least one object comprises:
(c1) computing a correlation between a residual image and the at least one object template, wherein the residual image is the holographic image;
(c2) determining a location in the residual image that maximizes the computed correlation as a detected object, and determining a strength of the maximized correlation;
(c3) updating the residual image as a difference between the residual image and the object template convolved with a delta function at the determined location and weighted by the strength of the maximized correlation; and
(c4) repeating steps (c1)-(c3) using the updated residual image until the strength of the maximized correlation reaches a pre-determined threshold.

10. The method of claim 9, wherein two or more object templates are obtained and wherein the step of determining a location in the residual image that maximizes the computed correlation further comprises determining an object template that maximizes the computed correlation.

11. The method of claim 9, wherein at least three object templates are obtained.

12. The method of claim 7, wherein the step of obtaining at least one object template comprises:
(b1) selecting at least one patch from the holographic image as a candidate template;
(b2) detecting at least one object in the holographic image using the candidate template;
(b3) storing the detected objects and the corresponding candidate template;
(b4) updating the candidate template based upon the corresponding detected objects; and
(b5) repeating steps (b2)-(b4) until a change in the candidate template is less than a pre-determined threshold.

13. The method of claim 12, wherein the at least one patch is selected at random.

14. The method of claim 12, wherein two or more patches are selected as candidate templates.

15. A non-transitory computer-readable medium having stored thereon a computer program for instructing a computer to:
(a) obtain a holographic image having one or more objects depicted therein;
(b) obtain at least one object template representing the object to be detected; and
(c) detect at least one object in the holographic image.
